(19) United States
(12) Patent Application Publication
(10) Pub. No.: US 2004/0267764 A1
(43) Pub. Date: Dec. 30, 2004

(54) Method to efficiently describe configuration settings in a standardized format

(76) Inventors: Michael A. Rothman, Gig Harbor, WA (US); Vincent J. Zimmer, Federal Way, WA (US)

Correspondence Address: Cory G. Claassen, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/606,643

(22) Filed: Jun. 25, 2003

(51) Int. Cl. G06F 17/00

(52) U.S. Cl. 707/100; 707/102

(57) ABSTRACT

A system and method for describing hardware configuration settings of a computing device. A central repository of data structures is built. The data structures are provided to the central repository by hardware entities of the computing device. Hardware configuration settings of the hardware entities are displayed using a browser. The hardware configuration settings are based at least in part on the data structures provided to the central repository by the hardware entities.

### TECHNICAL FIELD

This disclosure relates generally to describing hardware configuration settings in a standardized format, and in particular but not exclusively, relates to describing hardware configuration settings using a markup language for display in a browser.

### BACKGROUND INFORMATION

Consoles use various terminal types for displaying data and various standards for encoding data and communicating the data across a network. One such terminal type is a PC-ANSI terminal that follows commands in the ANSI standard terminal language. PC-ANSI terminals use escape sequences to control the cursor, clear the screen and set colors. Another such terminal type is the asynchronous VT100 terminal.

Various methods of encoding data include American Standard Code for Information Interchange (“ASCII”), Unicode, and Universal Transformation Format (“UTF”). ASCII is a binary code for text and is the built-in character code used by most computers on the market today. ASCII is a 7-bit code providing 128 character combinations, including 32 control characters. Unicode is a superset of the ASCII character set that uses 16 bits to encode 65,536 characters and is able to incorporate the alphabets of most of the world's languages. UTF is a method of converting 16-bit Unicode characters into the 7-bit ASCII code.

One advantage to the above encoding schemes is that they efficiently and compactly transmit data across a network for display on a remote console. Another advantage is their almost universal acceptance. Thus, these encoding schemes have been used by firmware and/or pre-boot software for conveying information to the user of a computer. However, these encoding schemes tradeoff richness in their ability to convey information for simplicity and efficiency. For example, conventional terminal types have specific limitations with regards to conveying semantic information such as “Did the user hit the F8 key?” Oftentimes, certain key sequences have no corollary in ASCII or Unicode and therefore it is impossible to assume that a remote console will have the ability to transmit and receive semantic information.

One language that attempts to combine a universally interchangeable data format with rich information storage capabilities is Standard Generalized Markup Language (“SGML”). SGML is a text-based language that uses markup data in a manner that is self-describing. However, SGML is a complicated language that requires extensive infrastructure to parse and is not well suited for data interchange over a network. Hence, Extensible Markup Language (“XML”) was created specifically for data interchange over the web. XML is a simplified subset of SGML that retains the self-describing attributes of SGML and thus the ability to convey semantic information such as “Did the user hit the F8 key?”

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a system for describing hardware configuration settings of a computing device in a browser, in accordance with an embodiment of the present invention.

FIG. 2 is a block diagram illustrating a system for describing hardware configuration settings of a computing device in a browser using a markup language, in accordance with an embodiment of the present invention.

FIG. 3A illustrates internal forms representation (“IFR”) source code and an IFR binary of an example data structure for describing hardware configuration settings of a hardware entity, in accordance with an embodiment of the present invention.

FIG. 3B illustrates an example IFR data structure and corresponding XML data structure for describing hardware configuration settings of a hardware entity, in accordance with an embodiment of the present invention.

FIG. 4 is a flow diagram illustrating a process to describe hardware configuration settings of a computing device using a markup language for display in a browser, in accordance with an embodiment of the present invention.

FIG. 5 is a block diagram illustrating a system for describing hardware configuration settings of a computing device to a remote console, in accordance with an embodiment of the present invention.

### DETAILED DESCRIPTION

Embodiments of a system and method for describing hardware configuration settings are described herein. In the following description numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise. A “browser” is defined herein to be an application program, executed during either a pre-boot runtime or an operating system (“OS”) runtime, that allows a user to navigate through and read text files and optionally allows the user to input changes to update the text files. A browser may include further functionality for displaying graphics. One example of a browser is a web browser.

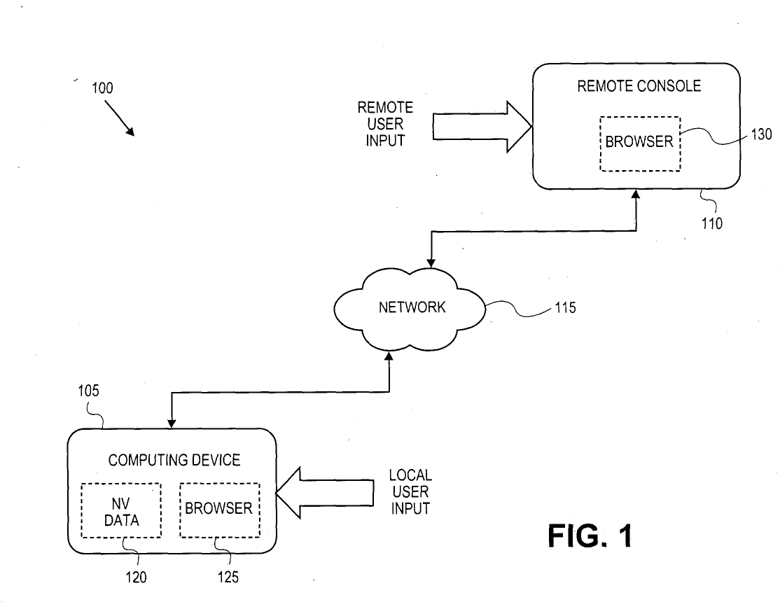

FIG. 1 is a block diagram illustrating a system 100 for describing hardware configuration settings of a computing device 105 in a browser using a markup language, in accordance with an embodiment of the present invention. In the illustrated embodiment, system 100 includes computing device 105 communicatively coupled to a remote console 110 via a network 115. In the illustrated embodiment, computing device 105 includes nonvolatile (“NV”) data 120 and a browser 125 and remote console 110 includes a browser 130.

Embodiments of computing device 105 and remote console 110 include, but are not limited to, a personal computer, a workstation, a notebook computer, a server, a handheld computer, and the like. Embodiments of network 115 include both wired and wireless networks, such as local area networks (“LANs”), wide area networks (“WANs”), the Internet, and the like.

In one embodiment, browser 125 executing on computing device 105 displays hardware configuration settings of computing device 105 to a local user of computing device 105. In one embodiment, the local user may optionally effect changes to the hardware configuration settings of computing device 105 by inputting changes into browser 125. As described below, these changes to the hardware configuration settings of computing device 105 are implemented by changes to NV data 120.

In one embodiment, a remote user of remote console 110 can view the hardware configuration settings of computing device 105 using browser 130 operating on remote console 110. In one embodiment, the remote user may optionally effect changes to the hardware configuration settings of computing device 105 by inputting changes into browser 130. These changes are transmitted across network 115 to computing device 105 and implemented by changes to NV data 120.

Thus, embodiments of the present invention provide techniques to view current hardware configuration settings and implement changes to the hardware configuration settings of computing device 105 via browsers 125 and/or 130. In one embodiment, browsers 125 and 130 are web browsers, such as Internet Explorer, Netscape Navigator, or the like.

The hardware configuration settings of computing device 105 that may be viewed and/or changed include system state settings of various hardware entities making up computing device 105, policy settings of the various hardware entities, firmware and/or hardware settings, and the like. The hardware configuration settings of computing device 105 are saved as NV data 120. Thus, in one embodiment, NV data 120 includes NV variables saved in bit registers that are toggled in response to changes input into one of browsers 125 and 130. In yet another embodiment, NV data 120 is saved in larger data registers or NV memory devices that can be updated with new data. It is appreciated that NV data 120 may saved in a single firmware unit on a motherboard and/or in option read only memories (“ROMs”) of multiple hardware entities of computing device 105. The various firmware units and/or option ROMs used to store NV data 120 may include ROMs, programmable ROMs, erasable programmable ROMs, electrically erasable programmable ROMs, flash memory, and the like.

In one embodiment, viewing and/or changing the hardware configuration settings of computing device 105 may be accomplished during a pre-boot runtime of computing device 105, prior to an OS taking control. In one embodiment, viewing and/or changing the hardware configuration settings of computing device 105 may be executed during an OS runtime of computing device 105, after the OS is loaded and executing. Thus, various embodiments of the present invention may implement the functionality described herein using firmware applications, OS applications, or a combination thereof.

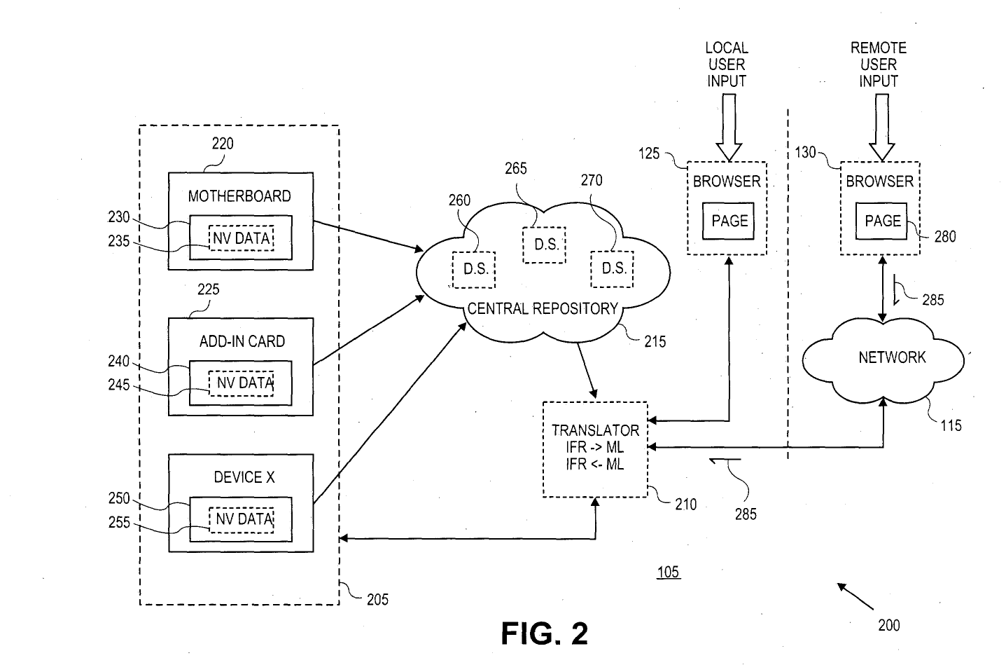

FIG. 2 is a block diagram illustrating a system 200 for describing the hardware configuration data of computing device 105 in either browser 125 or browser 130 using a markup language, in accordance with an embodiment of the present invention. System 200 is a more detailed block diagram of one embodiment of system 100. In the illustrated embodiment, system 200 includes hardware entities 205, a translator 210, a central repository 215, and browser 125, which are all elements of one embodiment of computing device 105. The illustrated embodiment of system 200 further includes network 115 communicatively coupling browser 130 executing on remote console 110 with translator 210 executing on computing device 105.

In one embodiment, hardware entities 205 include a motherboard 220, an add-in card 225 (e.g., PCI card or the like), and various other hardware entities represented by device X. Motherboard 220 further includes a firmware unit 230 to store NV data 235. Add-in card 225 includes a firmware unit 240 to store NV data 245. Device X includes a firmware unit 250 to store NV data 255. In one embodiment, NV data 235, 245, and 255 collectively correspond to NV data 120, illustrated in FIG. 1.

Central repository 215 is a memory-based repository for storing data structures 260, 265, and 270. Data structures 260 represent one or more data structures and 270 each represent one or more data structures exported by add-in card 225 and device X, respectively. Therefore, each of hardware entities 205 can export one or more data structures to central repository 215 and in return are allocated their own namespace for various software entities running on computing device 105 (e.g., translator 210 and browser 125) or external software entities running on external consoles (e.g., browser 130) to interact directly or indirectly with hardware entities 205. Data structures 260, 265, and 270 are initially stored as binary files in firmware units 230, 240, and 250, respectively, but are subsequently contributed to central repository 215 to build central repository 215. In one embodiment, central repository 215 is created in system memory (e.g., system RAM) of computing device 105.

Data structures 260, 265, and 270 may include strings, forms, methods, and the like for interacting with their respective hardware entities 205. In one embodiment, data structures 260, 265, and 270 are encoded in an internal form representation (“IFR”), which is both compact and capable of conveying semantic information such as “Did the user hit the F8 key?” In one embodiment, the IFR encoding is highly amenable to translation into standard generalized markup language (“SGML”) type formats including extensible markup language (“XML”).

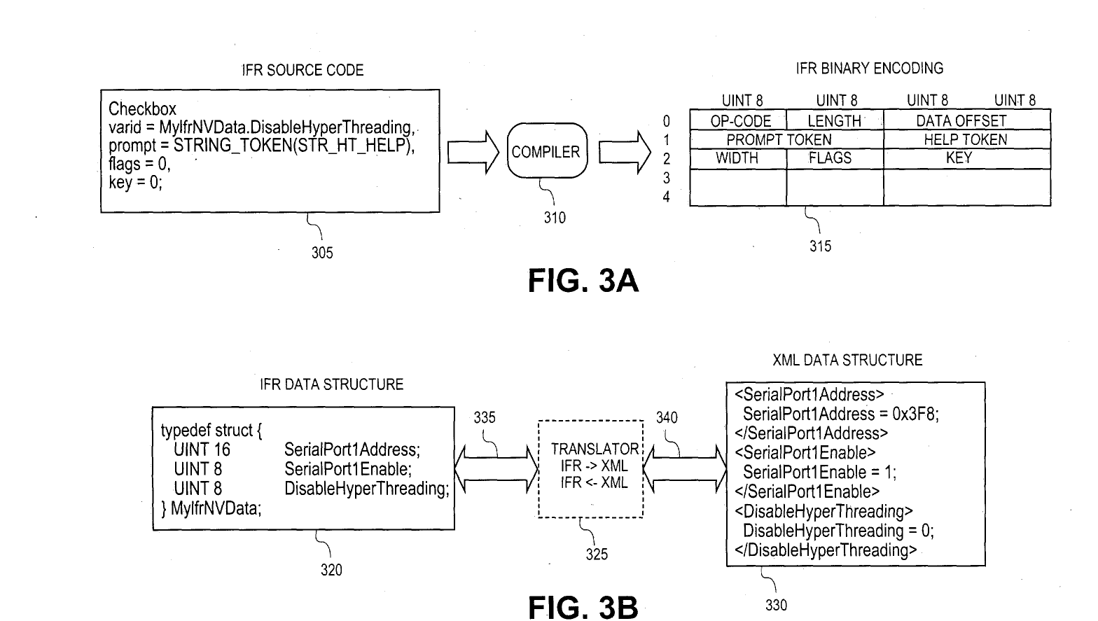

FIGS. 3A and 3B illustrate IFR encoding of an example data structure for describing the hardware configuration settings of hardware entities 205, in accordance with an embodiment of the present invention. FIG. 3A illustrates IFR source code 305 for a checkbox to disable hyper threading. IFR source code 305 is compiled by compiler 310 to generate IFR binary encoding 315. IFR Binary encoding 315 is an example encoding for the binary files of data structures 260, 265, and 270 stored in firmware units 230, 240, and 250, respectively. The fields of IFR binary encoding 315 comprise 8-bit and 16-bit unsigned integer values that are described in Table 1, below.

TABLE 1

| FIELD | DESCRIPTION |
|---|---|
| OP-CODE | Defines which op-code encoding follows (e.g., checkbox, text |
| | field, subtitle, password op-code, pick list, etc.) |
| LENGTH | Length of op-codes encoding |
| DATA | Offset address location where data is stored in |
| OFFSET | one of firmware units 230, 245, and 255 |
| PROMPT | Token reference corresponding to a prompt string saved in |
| TOKEN | central repository 215 (e.g., “Do you want to disable hyper |
| | threading?” |
| HELP | Token reference corresponding to a context sensitive help |
| TOKEN | string saved in central repository 215 |
| WIDTH | Size of data saved starting at data offset address in one of |
| | firmware units 230, 245, and 255 |
| FLAGS | Used for various indications based on op-code (e.g., |
| | current/default settings of a checkbox) |
| KEY | Value to be passed to entity calling data structure; private |
| | handshake |

It should be appreciated that Table 1 is one example of a possible IFR binary encoding. The fields that make up Table 1 are not all necessary and some fields may not be used for a particular op-code, while being used for other op-codes. Furthermore, some fields may be eliminated from various embodiments of IFR binary encoding 315, while other fields may be added as is needed. For example, the prompt token, the help token, the flags, and the key may be eliminated from IFR binary encoding 315 as needed. In other embodiments, the prompt token, the help token, the flags, and the key, or some combination thereof may simply have zero values to indicate that they are not used in connection with the particular op-code. As will be appreciated by those of ordinary skill in the art, the particular order or arrangement of the fields of IFR binary encoding 315 may be rearranged to better suit the needs of the particular embodiment. However, the various embodiments of IFR binary encoding 315 should be amenable to translation into a markup language for displaying data structures 260, 265, and 270 in browsers 125 and/or 130.

FIG. 3B illustrates an example IFR data structure 320 and a corresponding XML data structure for describing hardware configuration settings of a serial port, in accordance with an embodiment of the present invention. IFR data structure 320 is an example of one of data structures 260, 265, 270, illustrated in FIG. 2. IFR data structure 320 corresponds to an IFR binary encoding that has been parsed and formatted for readability.

IFR data structure 320 includes a 16-bit unsigned integer value representing an address of a serial port 1, an 8-bit unsigned integer value indicating the serial port 1 is enabled, and an 8-bit unsigned integer value indicating that hyper threading is disabled for serial port 1. The 8-bit unsigned integer value for disabling hyper threading in IFR data structure 320 corresponds to the example IFR source code 305 of a checkbox for disabling hyper threading. Therefore, a single IFR data structure may be comprised of several IFR binary encodings.

Translator 325 is an example of one embodiment of translator 210, illustrated in FIG. 2. Translator 325 translates/converts IFR data structure 320 into an XML data structure 330. Furthermore, as is illustrated with the double-sided arrows 335 and 340, translator 325 is capable of receiving XML data structures and translating/converting them into IFR data structures for interacting with hardware entities 205 (e.g., enabling/disabling hyper threading of a serial port on motherboard 220). Translator 325 further acts as an XML parser parsing XML data structures to update NV data 235, 245, and 255 with data received in the XML data structures.

XML data structure 330 is written in a standardized language (XML) that is amenable to data extraction and display in browsers, such as browser 125 and 130. Additionally, it is relatively compact yet capable of communicating semantic questions like “Did the user click the box for disabling hyper threading of serial port 1?” Therefore, XML data structure 330 along with other formatting information (e.g., hyper text transport protocol) is ideal for communicating the hardware configuration settings of computing device 105 over a network (e.g., LAN, WAN, the Internet) for display on remote console 110. It should be appreciated that XML is only an example of one markup language and that other compact markup languages capable of conveying semantic information described above may be used in place of XML.

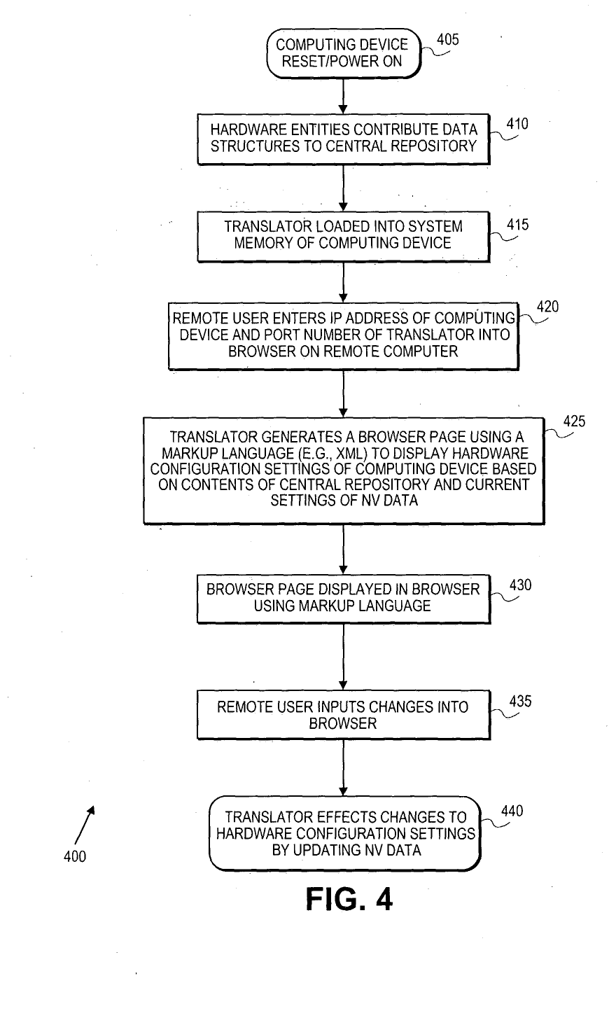

Turning now to FIG. 2 and FIG. 4, system 200 operates as illustrated by a process 400 to describe the hardware configuration settings of computing device 105 using a markup language for display in browser 130, in accordance with an embodiment of the present invention. Process 400 describes the interaction between browser 130 executing on remote console 110 and computing device 105, but is equally applicable to similar interactions using browser 125 executing on computing device 105.

In a process block 405, computing device 105 is powered-on. A powered-on event may be the result of the local user turning computing device 105 on after being powered-off, or a local or remote reset of computing device 105. After process block 405, computing device 105 proceeds through early system initialization to execute a pre-boot program called a basic input output system (“BIOS”), which may include a power on self-test (“POST”) among other tasks. Following the POST, central repository 215 is created in system memory (e.g., system RAM) of computing device 105 when hardware entities 205 contribute data structures 260, 265, and 270 stored as binaries files in each of their respective firmware units 230, 240, and 250 (process block 410).

In a process block 415, translator 210 is loaded into the system memory and executed by computing device 105. In one embodiment, translator 210 is loaded into the system memory during a pre-boot runtime (e.g., prior to loading the OS into system memory) of computing device 105. In one embodiment, translator 210 is a firmware application stored in firmware unit 230 of motherboard 220, such as an application compliant with an extensible firmware interface specification, version 1.10, Dec. 1, 2002, developed by Intel Corporation.

In one embodiment, translator 210 is an OS application stored on a storage device coupled to computing device 105, such as a hard disk. In this embodiment, translator 210 is loaded into the system memory and executed by computing device 105 during the OS runtime (e.g., after the OS is loaded into system memory).

Once translator 210 is loaded and executing, the remote user can change hardware configuration settings of hardware entities 205 via browser 130. In a process block 420, the remote user requests a browser page from translator 210 by entering into browser 130 an IP address of computing device 105 and a port number that translator 210 is configured to monitor. In one embodiment, translator 210 is configured to monitor the standard HTTP port.

In a process block 425, in response to the request for a browser page, translator 210 generates a browser page 280 displaying the hardware configuration settings of hardware entities 205. Browser page 280 is generated by translator 210 with reference to data structures 260, 265, and 270 stored in central repository 215. In some cases, data structures 260, 265, and 270 point to current settings of NV data 235, 245, and 255. In these cases, browser page 280 is further generated with reference to the current settings of NV data 235, 245, and 255. As discussed above, in one embodiment, data structures 260, 265, and 270 are coded in an efficient and compact IFR language. To convey the hardware configuration settings to browser 130, translator 210 converts data structures 260, 265, and 260 into a markup language to convey and to describe the hardware configuration settings within browser page 280 displayed on browser 130 (process block 430). In one embodiment, XML is used to convey and to describe the hardware configuration settings.

In a process block 435, the remote user (or the local user in the case of browser 125) inputs changes into browser 130. These changes are received by translator 210 via network 115 as markup language (“ML”) data 285. In a process block 440, translator 210 parses ML data 285 and updates one or more of NV data 235, 245, and 255 to reflect the changes input into browser 130 by the remote user. In this manner, the hardware configuration settings of hardware entities 205 are displayed on remote console 110 and changed by inputting changes into browser 130.

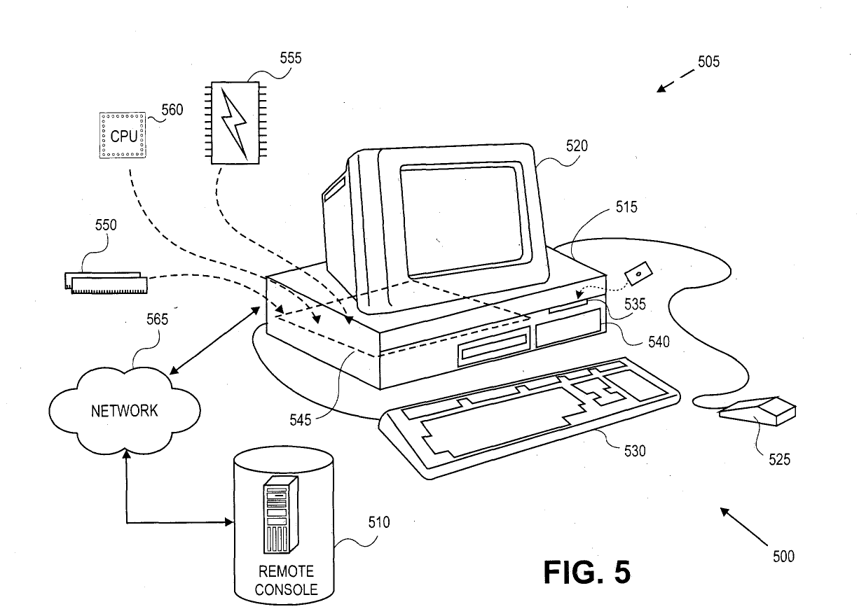

FIG. 5 illustrates one embodiment of a system 500 for describing hardware configuration settings of a computer 505 to a remote console 510, in accordance with an embodiment of the present invention. Computer 505 is an example of one embodiment of computing device 105 and remote console 510 corresponds to remote console 110. Computer 505 includes a chassis 515, a monitor 520, a mouse 525 (or other pointing device), and a keyboard 530. The illustrated embodiment of chassis 515 further includes a floppy disk drive 535, a hard disk 540, a power supply (not shown), and a motherboard 545 (corresponding to motherboard 220) populated with appropriate integrated circuits including system memory 550, firmware unit 555 (corresponding to firmware unit 230), and one or more processors 560.

In one embodiment, a network interface card (“NIC”) (not shown) is coupled to an expansion slot (not shown) of motherboard 545. The NIC is for connecting computer 505 to a network 565, such as a local area network, wide area network, or the Internet. In one embodiment network 565 is further coupled to remote console 510, such that computer 505 and remote console 510 can communicate.

Hard disk 540 may comprise a single unit, or multiple units, and may optionally reside outside of computer 505. Monitor 520 is included for displaying graphics and text generated by software and firmware programs run by computer 505 (e.g., browser 125 described above). Mouse 525 (or other pointing device) may be connected to a serial port, USB port, or other like bus port communicatively coupled to processor(s) 560. Keyboard 530 is communicatively coupled to motherboard 545 via a keyboard controller or other manner similar to mouse 525 for user entry of text and commands.

In one embodiment, firmware unit 555 stores NV data 235 and the binary files corresponding to data structures 260. In one embodiment, firmware unit 555 further stores translator 210. In one embodiment, hard disk 540 stores translator 210. After computer 505 is reset or powered-on, translator 210 is copied from either firmware unit 555 or hard disk 540 into system memory 550 and executed therefrom, as discussed above in connection with FIG. 4. Similarly, in one embodiment, after computer 505 is reset or powered-on, central repository 215 is created in system memory 550 and data structures 260 are contributed to central repository 215 from corresponding binary files in firmware unit 555. In one embodiment, remote console 510 executes browser 130 to receive browser page 280 from translator 210 and send ML data 285 to translator 210 via network 565 to interact with motherboard 545 of computer 505.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
building a central repository of data structures, the data structures provided to the central repository by hardware entities of a computing device; and
displaying hardware configuration settings of the hardware entities using a browser, the hardware configuration settings based at least in part on the data structures provided to the central repository.

2. The method of claim 1, further comprising changing at least one of the hardware configuration settings in response to input received via the browser.

3. The method of claim 1 wherein displaying the hardware configuration settings includes displaying the hardware configuration settings of the hardware entities using the browser running on a remote console communicatively coupled to the computing device via a network.

4. The method of claim 1 wherein displaying further includes displaying hardware configuration settings based at least in part on the data structures and nonvolatile data associated with the hardware entities.

5. The method of claim 2 wherein building the central repository further includes providing the central repository with the data structures being described using a language convertible to a markup language.

6. The method of claim 5 wherein the markup language is an extensible markup language (“XML”).

7. The method of claim 6 wherein displaying the hardware configuration settings includes executing a translator on the computing device, the translator to convert the data structures into the XML prior to displaying the hardware configuration settings using the browser.

8. The method of claim 6 wherein changing at least one of the hardware configuration settings includes executing a translator on the computing device, the translator to update nonvolatile data associated with the hardware entities with XML data received from the browser.

9. The method of claim 1 wherein the hardware entities include at least one of a motherboard and an add-in card of the computing device.

10. The method of claim 1 wherein displaying hardware configuration settings includes displaying policy settings of the hardware entities of the computing device using the browser, the policy settings based at least in part on the data structures provided to the central repository.

11. The method of claim 1 wherein building the central repository of the data structures includes building the central repository in a system memory of the computing device, the data structures obtained from binaries being stored in option read only memories (“ROMs”) of the hardware entities, the central repository being built during a pre-boot runtime of the computing device.

12. A method, comprising:
converting hardware configuration settings being stored in firmware of a computing device to a markup language; and
conveying the markup language to a browser to display the hardware configuration settings in the browser.

13. The method of claim 12, further comprising:
changing at least one of the hardware configuration settings stored in the firmware in response to input received via the browser.

14. The method of claim 13 wherein the browser is a web browser executing on a remote console communicatively coupled to the computing device via a network.

15. A computer-accessible medium that provides instructions that, if executed by a computing device, will cause the computing device to perform operations comprising:
generating a browser page to display hardware configuration settings of hardware entities of a computing device using a browser, the hardware configuration settings based at least in part on data structures provided by the hardware entities; and
changing at least one of the hardware configuration settings in response to input received via the browser.

16. The computer-accessible medium of claim 15 wherein the instructions for generating the browser page further include instructions to generate the browser page to be displayed in a web browser of a remote console communicatively coupled to the computing device via a network.

17. The computer-accessible medium of claim 15 wherein the instructions for generating the browser page further include instructions to display the hardware configuration settings based at least in part on the data structures and nonvolatile data associated with the hardware entities.

18. The computer-accessible medium of claim 15 wherein the data structures are described using a language convertible to a markup language.

19. The computer-accessible medium of claim 18 wherein the markup language is an extensible markup language (“XML”).

20. The computer-accessible medium of claim 19 wherein the instructions for generating the browser page include instructions to execute a translator to convert the data structures into the XML prior to generating the browser page to display the hardware configuration settings.

21. The computer-accessible medium of claim 15, wherein the hardware entities include at least one of a motherboard and an add-in card of the computing device.

22. The computer-accessible medium of claim 15, wherein the instructions for generating the browser page include instructions to generate the browser page during a pre-boot runtime of the computing device.

23. A system, comprising:
a computing device, including:
a processor;
multiple hardware entities communicatively coupled to the processor; and
a nonvolatile memory unit coupled to the processor, the nonvolatile memory unit having stored therein a translator to be executed by the processor, the translator to convert data structures corresponding to the multiple hardware entities into a markup language to generate a browser page to display hardware configuration settings of the multiple hardware entities in a browser.

24. The system of claim 23, further comprising:
a network communicatively coupled to the computing device; and
a remote console communicatively coupled to the network, the browser to execute on the remote console, the translator to update nonvolatile data associated with at least one of the hardware entities in response to markup language data received from the browser.

25. The system of claim 24, wherein the browser is a web browser.

26. The system of claim 23 wherein the browser is to be executed by the computing device and wherein the translator to update nonvolatile data associated with at least one of the hardware entities in response to markup language data received from the browser.

27. The system of claim 23 wherein the hardware entities each include a firmware unit, the firmware units of the hardware entities having the data structures stored therein as binaries, the binaries to be contributed as the data structures to a central repository.

28. The system of claim 27 wherein the binaries are to be contributed as the data structures to the central repository during a pre-boot runtime of the computing device.

29. The system of claim 23 wherein the nonvolatile memory unit comprises a firmware unit of a motherboard of the computing device.

30. The system of claim 23 wherein the nonvolatile memory unit comprises a hard disk of the computing device.
